(19) United States
(12) Patent Application Publication
(10) Pub. No.: US 2001/0012990 A1
(43) Pub. Date: Aug. 9, 2001

(54) Method for generating a client/server model of a multi-protocol layered transmissions network

(76) Inventors: Yakov Zimmerman, Elkana (IL); Einat Gabso, Bat-Yam (IL); Merav Cohen, Bet-Arie (IL); Natalia Malamud, Kefar-Sava (IL)

Correspondence Address: NATH & ASSOCIATES, 1030 15th STREET, 6TH FLOOR, WASHINGTON, DC, 20005, US

(21) Appl. No.: 09/758,354

(22) Filed: Jan. 12, 2001

(30) Foreign Application Priority Data
Jan. 14, 2000 (IL) 134047

(51) Int. Cl. G06F 17/50

(52) U.S. Cl. 703/13

(57) ABSTRACT

For use in a multi-protocol Network Management System application for managing a multi-protocol layered transmissions network including a plurality of network elements, a method for generating a model of the multi-protocol layered transmissions network, the method comprising the steps of: determining the protocol layers in the multi-protocol layered transmissions network; and for each protocol layer, mapping out an overlay including the network elements operative in the protocol layer, and at least one physical link and/or the logical links interconnecting pairs of network elements where transport service along a logical link is at least partially provided by a transmission path on a protocol layer directly underlying the protocol layer, and the pair of association links between each logical link and its associated transmission path.

### FIELD OF THE INVENTION

The present invention is in the field of digital telecommunication systems in general, and Network Management System (NMS) applications, in particular.

### BACKGROUND OF THE INVENTION

Modern digital telecommunication systems employ single protocol network elements and/or hybrid protocol network elements to form multiprotocol layered transmissions networks. Two network elements can be interconnected over a physical link, or over a logical link where the actual transmission path is on an underlying protocol layer effectively acting as a server protocol layer in a client/server relationship to a client protocol layer requiring a transport service. Each protocol layer is conventionally managed by a protocol layer specific Network Management System (NMS) application, thereby negating client/server relationships between pairs of protocol layers to the detriment of the management of a multi-protocol layered transmissions network.

### SUMMARY OF THE INVENTION

In accordance with the present invention, there is provided for use in a multi-protocol Network Management System application for managing a multiprotocol layered transmissions network including a plurality of network elements, a method for generating a model of the multi-protocol layered transmissions network, the method comprising the steps of:

(a) determining the protocol layers in the multi-protocol layered transmissions network; and

(b) for each protocol layer, mapping out an overlay including the network elements operative in the protocol layer, and at least one physical link and/or the logical links interconnecting pairs of network elements where transport service along a logical link is at least partially provided by a transmission path on a protocol layer directly underlying the protocol layer and the pair of association links between each logical link and its associated transmission path.

The multi-protocol Network Management System (NMS) application implementing the method of the present invention is preferably capable of automatically determining the physical links and the logical links in each protocol layer, and the subsequent association of each logical link to the corresponding transmission path providing the actual transport service thereto. Additionally, the envisaged multi-protocol NMS application preferably supports operator intervention in the client/server model to provide greater flexibility, for example, for enabling the establishment of links with a network element whose adaptation functionality from one technology to another is not directly under the control of the NMS application, enabling the use of the client/server model for modeling purposes, and the like. By virtue of the present invention, it is envisaged that a multi-protocol NMS application may facilitate management of multi-protocol layered transmissions networks including inter alia a richer content wise representation of a transmissions network on a Graphical User Interface (GUI), alarm management, event propagation, protected path provisioning, and the like.

### BRIEF DESCRIPTION OF THE DRAWINGS

In order to understand the invention and to see how it can be carried out in practice, a preferred embodiment will now be described, by way of a non-limiting example only, with reference to the accompanying drawings, in which similar parts are likewise numbered, and in which:

FIG. 1 is a schematic representation showing the network topology of a multi-protocol layered transmissions network;

FIG. 2 is a flow diagram showing the steps of generating a client/server model of a multi-protocol layered transmissions network as carried out by a multi-protocol Network Management System (NMS) application of the present invention;

FIG. 3 is a schematic representation showing the client/server hierarchy of the IP/SDH/DWM protocol layers of the transmissions network of FIG. 1;

FIG. 4 is a schematic representation showing a 3D representation of the client/server model of the transmissions network of FIG. 1;

FIG. 5A is a schematic representation of the top view of the overlay of the IP protocol layer of the client/server model of FIG. 4;

FIG. 5B is a schematic representation of the overlay of the IP protocol layer of the transmissions network of FIG. 1 as generated by a conventional IP NMS application;

FIG. 6A is a schematic representation of the top view of the overlay of the SDH protocol layer of the client/server model of FIG. 4;

FIG. 6B is a schematic representation of the overlay of the SDH protocol layer of the transmissions network of FIG. 1 as generated by a conventional SDH NMS application;

FIG. 7 is a schematic representation of the overlay of the WDM protocol layer of the client/server model of FIG. 4; and

FIG. 8 is a flow diagram showing the steps of applying the model of the present invention in alarm analysis.

### DETAILED DESCRIPTION OF THE DRAWINGS

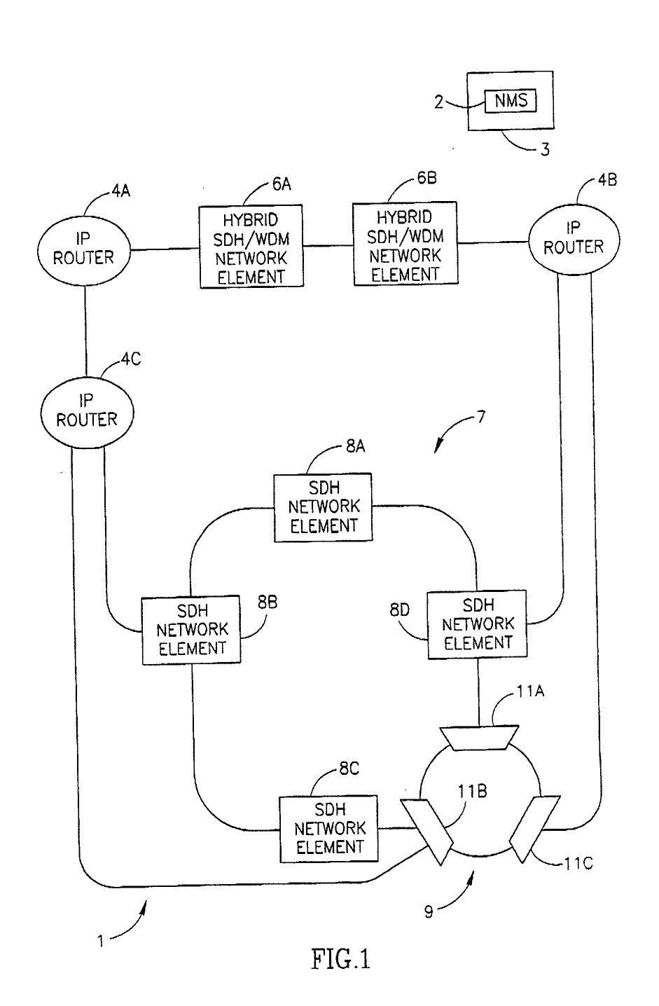

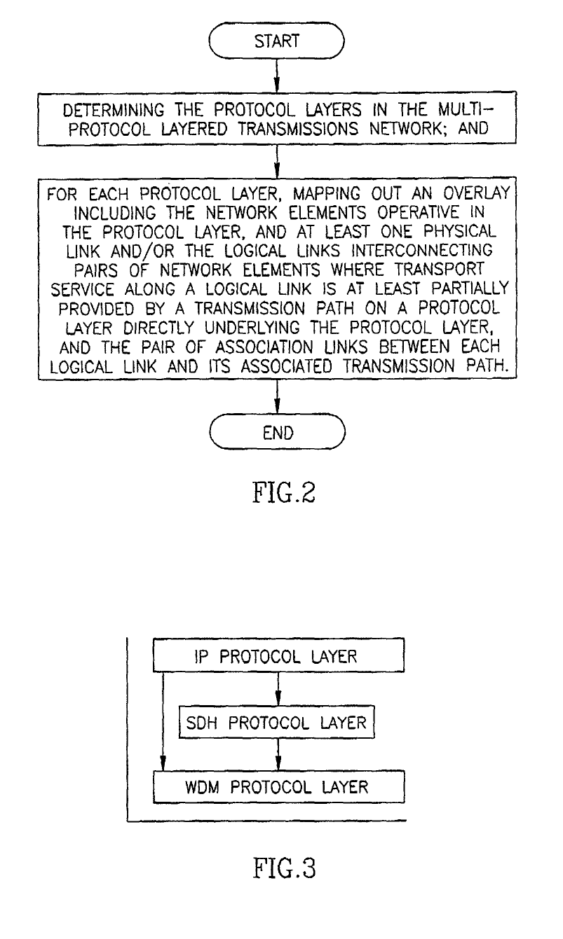

FIG. 1 shows a multi-protocol layered transmissions network 1 managed by a multi-protocol Network Management System (NMS) application 2 running on a computer 3. The transmissions network 1 includes networks elements operative on one or more of three protocol layers, namely, IP, SDH and WDM, and in which the WDM protocol layer acts as a server protocol layer to both IP and SDH client protocol layers, and the SDH protocol layer acts as a server protocol layer to the IP client protocol layer (see FIG. 3). The network elements include three IP routers 4A, 4B and 4C, a pair of hybrid SDH/WDM network elements 6A and 6B, an SDH ring 7 including SDH network elements 8A, 8B, 8C, and 8D, and an WDM ring 9 including WDM network elements 11A, 11B, and 11C.

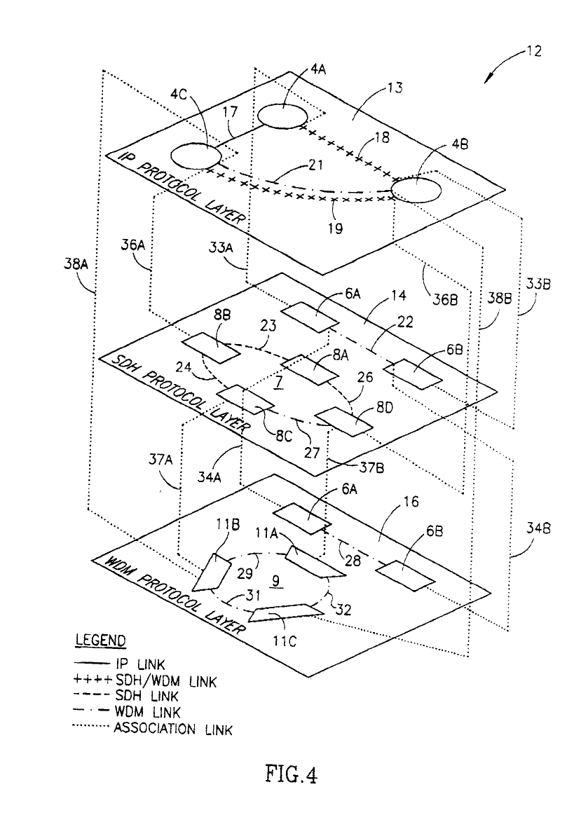

FIG. 4 shows a 3D representation of a model 12 of the transmissions network 1 as generated in accordance with the method of the present invention. Model 12 includes three overlays 13, 14 and 16 for the IP, SDH and WDM protocol layers of the transmissions network 1, respectively. Model 12 includes the physical links of each protocol layer, its logical links, and the so-called association links for associating each logical link to the transmission path providing the transport service thereto with one exception being the most underlying protocol layer, in this case the WDM protocol layer, which only includes physical links.

FIG. 4 also shows the Legend of the different representations of the different IP/SDH/WDM technologies, the representation of so-called hybrid SDH/WDM logical links which rely on transport services from both SDH and DWM physical links, and association links. These representations are constant per technology or combination of technologies in the sense that the same representation is used for a particular type of link irrespective of the actual overlays being displayed. These representations may also be employed when displaying overlays of protocol layers on a Graphic User Interface (GUI), thereby enabling visual discrimination therebetween. Alternatively, other approaches may be employed including inter alia color coding, different lines' thickness, and the like.

The computerized overlay 13 of the IP protocol layer includes four links as follows: A physical IP link 17 interconnecting the IP routers 4A and 4C. A logical SDH/DWM link 18 interconnecting the IP routers 4A and 4B. And, a logical SDH/DWM link 19 and a logical WDM link 21 interconnecting the IP routers 4B and 4C. The computerized overlay 14 of the SDH protocol layer includes five links as follows: A logical WDM link 22 interconnecting the SDH/WDM network elements 6A and 6B. Three physical SDH links 23, 24 and 26 interconnecting the pairs of SDH network elements (8A, 8B), (8B, 8C), and (8A, 8D) and a logical WDM link 27 interconnecting the pair of SDH network elements (8C, 8D). The computerized overlay 16 of the WDM protocol layer includes four links as follows: A physical WDM link 28 interconnecting the SDH/WDM network elements 6A and 6B. And, three physical WDM links 29, 31, and 32 in the WDM ring 9.

FIG. 4 also shows five pairs of association links as follows: A pair of association links 33A and 33B associating the logical SDH/WDM link 18 with the logical WDM link 22. A pair of association links 34A and 34B associating the logical WDM link 22 with the physical WDM link 28. A pair of association links 36A and 36B associating the logical SDH/WDM link 19 with the SDH ring 7. A pair of association links 37A and 37B associating the logical WDM link 27 with the WDM ring 9. A pair of association links 38A and 38B associating the WDM logical link 21 with the VVDM ring 9.

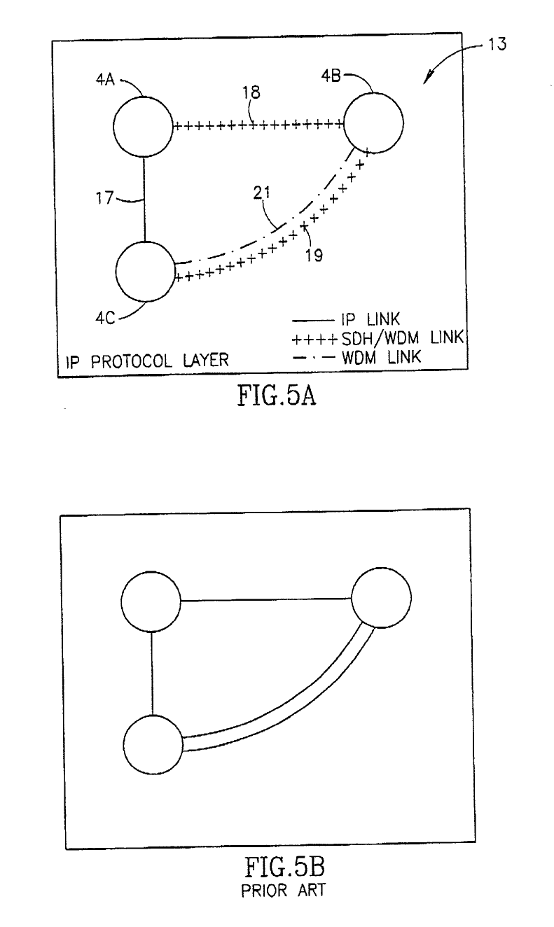

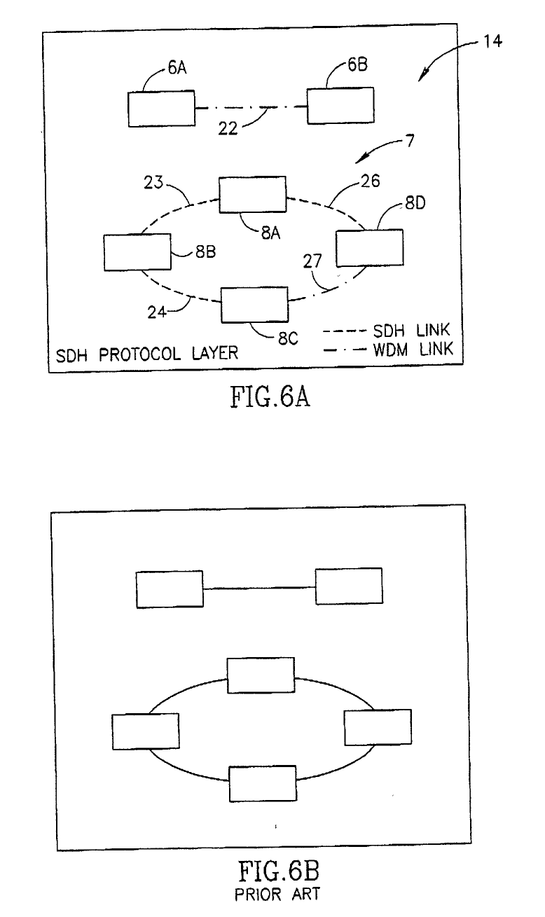

FIGS. 5A and 6A show that the overlays of the IP and SDH protocol layers 13 and 14 are richer content wise by virtue of the different technologies/combinations of technologies being displayed differently as opposed to their conventionally all being displayed identically as shown in FIGS. 5B and 6B.

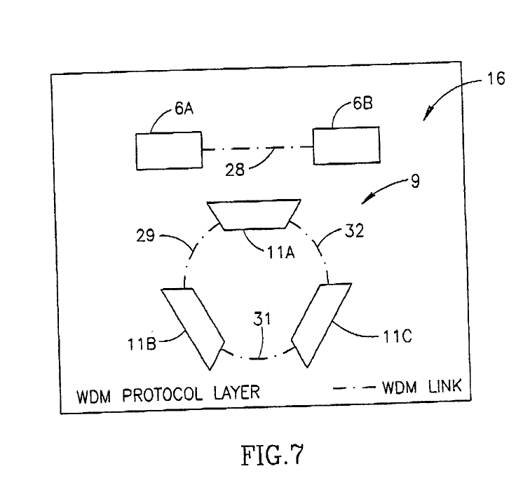

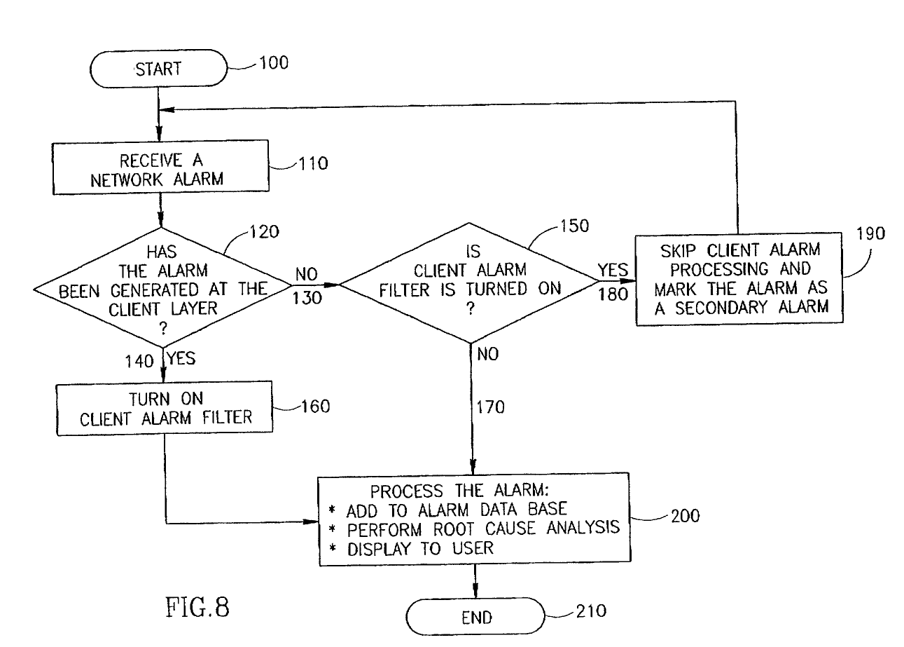

FIG. 7 illustrates the WDM protocol layer 16 wherein the three physical WDM links 29, 31 and 32 presents part of WDM ring 9, as previously explained.

As will be appreciated by a person skilled in the art, construction of a model as disclosed by the present invention can be used for a variety of applications. A flow diagram of one such non-limiting example of an application is illustrated in FIG. 8. As will also be appreciated by a man skilled in the art other applications such as impact analysis (e.g. evaluating the impact of a future operation at one or more layers, such as maintenance operation, on the operation at the client layer), circuit provisioning based on any desired parameter (e.g. distance, delay, degradation in the signal quality, protection requirements and the like) can be carried out by using such a model as provided by the present invention.

FIG. 8 presents a flow diagram showing the steps of an embodiment by which a model as disclosed by the present invention is used in alarm analysis application. One of the major problems associated with the management of networks of the prior art is, that once an alarm is generated, the operator is not able to identify in which layer of the multi-layered network lies the problem. In other words, if the cause for the alarm is at the client layer or in any of the other underlying layers. The major importance of this embodiment is to allow the operator to remove all alarms that are not generated at the upper (client) layer and to focus on those generated only at the server layer. If for example, one of the physical WDM links becomes inoperative, this event can be propagated onto the logical WDM link of the computerized overlay of the SDH protocol layer, and the logical WDM link on the computerized overlay of the IP protocol layer. Therefore, once an alarm is received (110), it is determined whether the alarm is associated the client layer or with any of the underlying layers (120). If the answer is no (130), it is determined whether the client alarm filter is turned on (150). The term “client alarm filter” is used herein to denote any means that is operative to eliminate different alarms that reach the client server and the primary cause for their generation is at a server layer associated with the client layer. If the answer to the latter step is affirmative (180) then there is no need to process a client alarm, the alarm may be marked as a non-client layer alarm (a secondary type of alarm) (190) and the process awaits the receipt of the next alarm.

If on the other hand, it is determined in step (120) that the alarm was generated at one of the underlying layers and not at the client layer (140), the client alarm filter is turned on and the alarm is removed from the list/database of client alarms (160). Following step (160), any one of the following steps may be taken or any combination thereof (200): processing the alarm, adding the alarm to the alarms database, performing root cause analysis of that current alarm and/or providing a display of the alarm.

By another embodiment of the invention, a user can determine whether a path selected satisfies any parameter set or a combination of a number of parameters. For such application, the user set his criteria for the circuit required, the systems finds one possible path through the multiple layers available in accordance with the path end points, and then it is determined whether the path to be provisioned fulfills the criteria set. Preferably, it is determined whether the criteria are met at the client layer and recursively the path is determined for all underlying layers while retaining these criteria. Such selection criteria are preferably selected from the group comprising: distance of transmission, delay allowed in receiving the transmission, degradation of the transmitted signals, protection constrains, and the like or any combination thereof. As will be appreciated by those skilled in the art, in addition or alternatively, the criteria may be used as part of an algorithm for choosing a preferred transmission path while taking into consideration the server layer characteristics.

While the invention has been described with respect to a limited number of embodiments, it will be appreciated that many variations, modifications, and other applications of the invention can be made within the scope of the appended claims.

1. For use in a multi-protocol Network Management System application for managing a multi-protocol layered transmissions network including a plurality of network elements, a method for generating a model of the multi-protocol layered transmissions network, the method comprising the steps of:
(a) determining the protocol layers in the multi-protocol layered transmissions network; and
(b) for each protocol layer, mapping out an overlay including the network elements operative in the protocol layer, and at least one physical link and/or the logical links interconnecting pairs of network elements where transport service along a logical link is at least partially provided by a transmission path on a protocol layer directly underlying the protocol layer, and the pair of association links between each logical link and its associated transmission path.

2. The method according to claim 1 and further comprising the step of displaying on a GUI an overlay of one protocol layer of the model with different technologies employed therein being displayed in visually distinctive manners.

3. The method according to either claim 1 or 2 and further comprising the step of displaying on a GUI a top view of the overlays of two or more protocol layers of the model superimposed one on the other.

4. The method according to any one of claims 1 to 3 and further comprising the step of displaying a 3D representation on a GUI of overlays of two or more protocol layers of the model including the pair of association links between each logical link and its associated transmission path.

5. A method according to claim 1, operative to distinguish between alarms generated at a client protocol layer and those generated and any of the underlying protocol layers.

6. A method according to claim 1, operative to allow the selection of a path in the multi-protocol layered transmissions network by using at least one selection criterion for the path to be provisioned.

7. A method according to claim 6, wherein said at least one selection criterion is selected from the group comprising: distance of transmission, delay allowed in receiving the transmission, degradation of the transmitted signals, protection constrains, or any combination thereof.

8. A system comprising a processor capable of carrying out the method of claim 1.
